(19) United States
(12) Patent Application Publication
(10) Pub. No.: US 2004/0208951 A1
(43) Pub. Date: Oct. 21, 2004

(54) Electric molding clamp assembly

(76) Inventor: Kenneth H. Bealer, Wilmington, NC (US)

Correspondence Address: WILLIAM J. MASON, MACCORD MASON PLLC, POST OFFICE BOX 1489, WRIGHTSVILLE BEACH, NC, 28480, US

(21) Appl. No.: 10/420,020

(22) Filed: Apr. 21, 2003

(51) Int. Cl. B29C 45/66

(52) U.S. Cl. 425/595

(57) ABSTRACT

An electrically powered, molding clamp assembly enables rapid closure of platens, while exerting a force sufficient to maintain the platens in the closed position during molding without the necessity of large horsepower motors of high energy. Force accumulators join at least one of the platens to rotatable threaded rods connecting the platens. A first electric drive means rotates the threaded rods at a first rotational speed to move one or both of the platens between open and closed positions, and a second electric drive means rotates the threaded rods at a second rotational speed less than said first rotational speed to move the accumulators between said uncompressed and compressed positions when the movable platen is in its closed position, creating a clamping force on the platens.

### BACKGROUND OF THE INVENTION

(1) Field of the Invention

The present invention relates to an electric molding clamp assembly, and in particular to a clamp assembly that can be rapidly closed, followed by exertion of a high clamping force during molding.

(2) Description of the Prior Art

A plastic molding clamp assembly is normally comprised of a pair of supports, known as platens, having inwardly facing, parallel mounting surfaces to carry mold sections. Each mold section includes a part of a mold cavity, so that the mold sections, when moved into facing contact, define a mold cavity corresponding to the exterior surface of the desired part. In some molding assemblies, e.g., assemblies of the type typically used for injection molding, one platen remains stationary while the other platen is moveable between open and closed positions along a pathway that is perpendicular to the mounting surfaces of the platens. In other molding assemblies, e.g., assemblies of the type used for blow molding, both platens are moveable between open and closed positions.

A molding clamp must meet two requirements. First, the clamp must be adapted to open and close rapidly, so that the time required to mold a given part is as short as possible and economically viable. Second, the clamp must exert a considerable force on the mold sections during molding to prevent molten plastic from escaping between the mold sections during molding.

Conventional molding clamps have relied on mechanical toggle arrangements or hydraulic cylinders to meet these requirements. More recently, efforts have been made to develop acceptable injection molding clamps using electrical drive means, such as an electric motor coupled to rotatable threaded rods, to carry the moveable platen between open and closed positions. The use of a single motor for this purpose has been unworkable, either because the size of the motor was cost prohibitive, because the speed of opening and closing was too slow, or because the clamping force was insufficient to prevent escape of plastic during molding.

Some prior art disclosures have suggested using two electric motors to achieve the desired objectives, with one motor being used to rapidly rotate threaded rods to effect rapid opening and closing, and a second motor to rotate the rods at a considerably slower speed, but at a considerably higher torque, to exert a clamping force on the mold sections once the molds are brought to their clamping position by the first motor. Representative of such disclosures are U.S. Pat. No. 4,929,165 to Inaba et al, and U.S. Pat. No. 5,190,714. Drive mechanisms other than a second motor have also be suggested, as exemplified by U.S. Pat. No. 6,186,770 to Ziv-Av.

However, prior art assemblies require large and expensive motors, with corresponding high-energy requirements, to maintain a sufficient clamping force. These motors and the energy required render the assemblies uneconomical, and thus commercially unacceptable. Thus, there still remains a need for a clamping assembly that will address these needs in an effective and economical manner.

### SUMMARY OF THE INVENTION

Generally, the molding clamp assembly of the invention is comprised of first and second platens, at least one of the platens being moveable, to support mating mold sections; resilient force accumulators carried on at least one of the platens; rotatable threaded rods connecting the platens; and a drive means to first move the platens between open and closed positions at a relatively high speed, and then to compress the force accumulators after the platens are in the closed position, thereby tightly clamping the mold sections together.

In one embodiment, the clamping assembly of the present invention is comprised of a base, which may be oriented horizontally, vertically or at an intermediate angle, that supports a fixed stationary platen, and a moveable platen slideable along the base between open and closed positions. The platens have facing, parallel, mold mounting surfaces to support mold sections that join to form a mold cavity when the moveable platen is in the closed position. In another embodiment, both platens are moveable inwardly during closing.

The platens, whether one or both are moveable, are connected by rotatable, threaded rods, also known as lead screws. The threaded rods are parallel to each other and to the pathway of the moveable platen or platens and perpendicular to the platen mold support surfaces. Preferably, the ends of the rods are rotatably attached to a support frame attached to the base and/or to a stationary platen. The rods may also extend through bores in one or both of the platens.

The threaded rods are joined to at least one of the platens by compressible force accumulators, preferably mounted on an exterior surface of a platen. For purposes of the present disclosure, a “force accumulator” is intended to mean a device that is compressible, and which stores energy when compressed, urging the device toward its uncompressed state. The force accumulators of the present invention generally include one or more springs, which may be in the form of washers having cupped and flattened states. A preferred force accumulator is commonly known as a disc spring or disc spring pack. A disc spring pack generally includes a plurality of springs arranged in a desired configuration. As used herein, it will be understood that the term “disc spring” encompasses disc springs with a single spring, as well as disc spring packs that incorporate a plurality of springs. A representative disc spring is known in the industry as a Belleville washer. Other force accumulators include compression springs, compressible urethanes, and pre-charged gas cylinders.

In the present invention, the force accumulators are adapted to be moved between uncompressed and compressed states after the moveable platen is in the closed position. In the assembly of force accumulators, e.g., disc springs, the compressible member may be held within the assembly under a small compressive force, primarily to maintain desired positioning of the components. For purposes of the present invention, assemblies of this type will still be considered to be “uncompressed,” the terms “uncompressed” and “compressed” as used herein referring to the deformation, or lack of deformation, of the compressible part of the force accumulator due to the force of the drive means.

The electric drive means used to reciprocate the platens between open and closed positions and to move the force accumulators between their uncompressed and compressed states is comprised of a plurality of threaded rods operatively connecting to a common drive shaft that is rotated by the electric drive means. During the molding cycle, initial rotation of the threaded rods moves the platens to their closed position. Compression of the force accumulators is effected by further rotation of the threaded rods. For example, the force accumulators may include threaded components, such as planetary rollers or ball screws, meshing with the threads of the threaded rods, so that rotation of the threaded rods causes linear movement of the force accumulators along the threaded rods.

Various transmission arrangements, such as belts and pulleys, may be used to connect the drive shaft and threaded rods. Other transmission means, e.g., gears or chain drives, will be apparent to one skilled in the art. Generally, the drive means includes a first drive configuration for reciprocating the platens between open and closed positions at a relatively high speed, and a second drive configuration for compressing the force accumulators at a considerably slower speed, but at the considerably higher force that is required to compress the force accumulators.

The drive means may be a single electric motor with gearing to provide alternate high speed and low speed drive connections to the drive shaft. However, the drive means is preferably comprised of two electric motors. A first motor is adapted to rotate the drive shaft at relatively high speed, and may be directly connected to the drive shaft by a belt and pulleys, or other transmission means. A second motor is adapted to rotate the drive shaft at relatively low speed, and may be connected to the drive shaft through a reduction gearbox. The drive shaft of the gearbox may serve as the common drive shaft. The drive and transmission means is configured to rotate all threaded rods at the same rate, thereby maintaining the platen mounting surfaces parallel to each other during opening and closing of the clamping assembly.

In operation, first and second mold sections are mounted on the platen mold section mounting surfaces, with each mold section including a portion of a desired mold cavity. The first motor is then engaged to rotate the drive shaft at a high speed to rapidly move one or both platens to their closed position, whereby the mold sections are substantially in contact with each other, i.e., in contact or only a small distance apart. The second motor is then energized to rotate the drive shaft at a slow speed, but at a high torque. Since the platens are in the closed position, rotation of the drive shaft by the second motor does not result in any significant linear movement of the moveable platen or platens.

Instead, rotation of the threaded rods results in linear movement of the force accumulators, compressing the springs or other resilient elements within the force accumulators. Preferably, the resilient elements are on the exterior side of a platen, creating a considerable force against the exterior surface of the platen, urging the platen toward the other platen. As a result, the mold sections held between the platens are clamped tightly together during molding.

Compression on the mold sections is maintained until the plastic has solidified. To prevent the compressed force accumulators from returning to their uncompressed states during the molding cycle, the second motor may be energized during all or a part of the molding cycle. Unlike prior art proposals, however, high-energy usage is not required during molding due to the presence of the force accumulators. Alternatively, the motor can be de-energized and a brake on the motor shaft can be used to prevent rotation of the lead screws during the molding cycle.

After the plastic has solidified, the high-speed motor is engaged in reverse to rapidly withdraw the moveable platen to the open position. Once the moveable platen is in the open position, the cycle can be repeated.

### BRIEF DESCRIPTION OF THE DRAWINGS

FIG. 1 is a side view of the preferred clamping assembly including a stationary platen and a moveable platen with the disc springs being mounted on the moveable platen.

FIG. 2 is a top view of the preferred clamping assembly.

FIG. 3 is a proximal end view of the preferred clamping assembly.

FIG. 4 is a proximal end view of the moveable platen of the preferred clamping assembly showing the four disc springs.

FIG. 5 is a detailed sectional side view of a disc spring carried on the moveable platen of the preferred embodiment.

FIG. 6 is a side view of a first alternative embodiment including two moveable platens carrying disc springs.

FIG. 7 is a side view of a second alternative embodiment including a stationary platen and a moveable platen, with the disc springs being mounted on the stationary platen.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

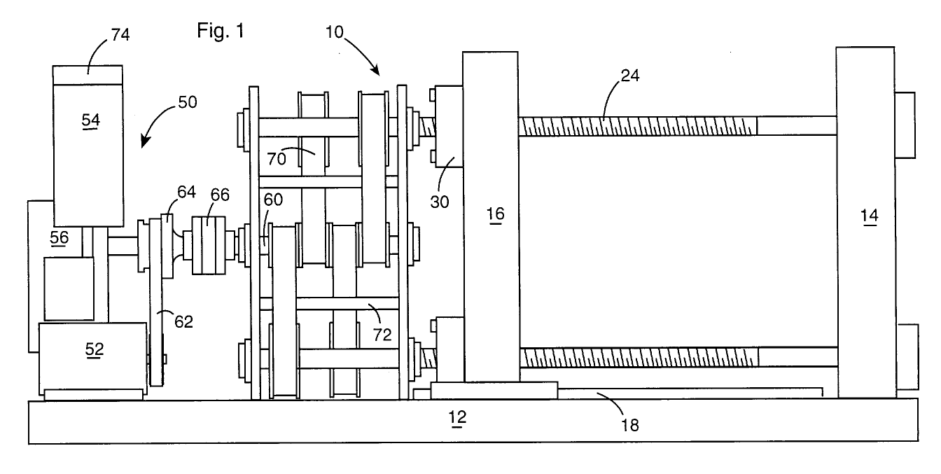

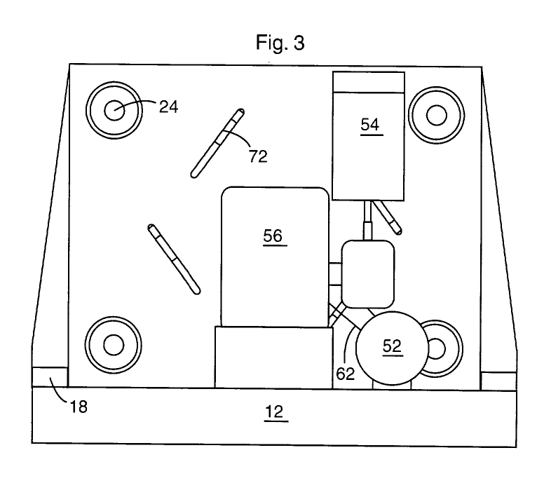

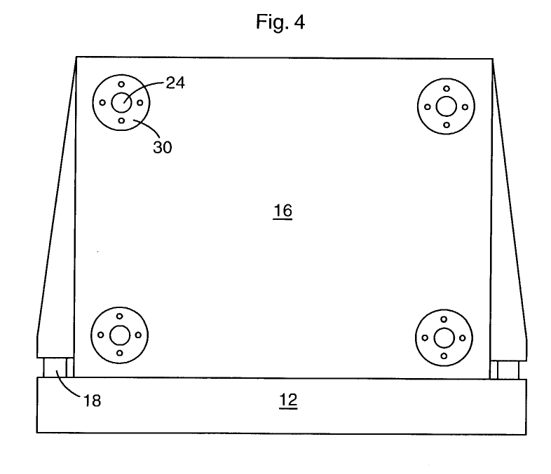

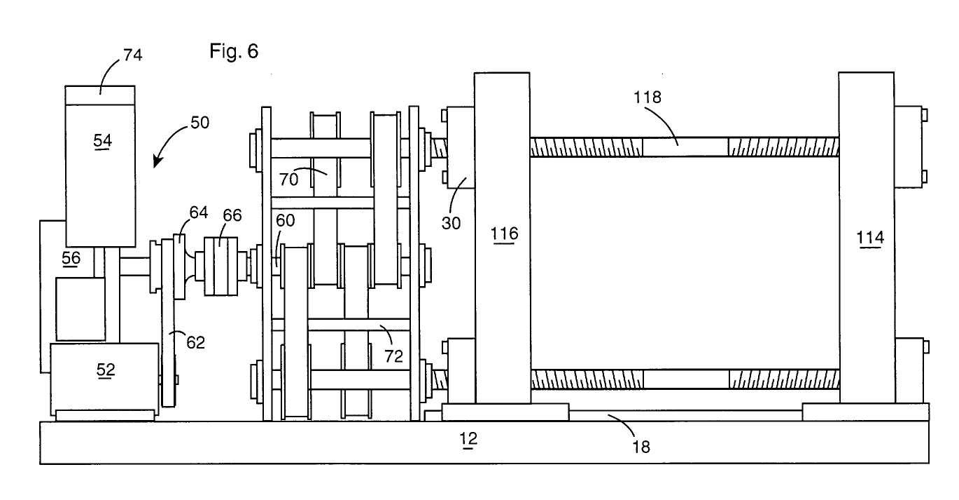

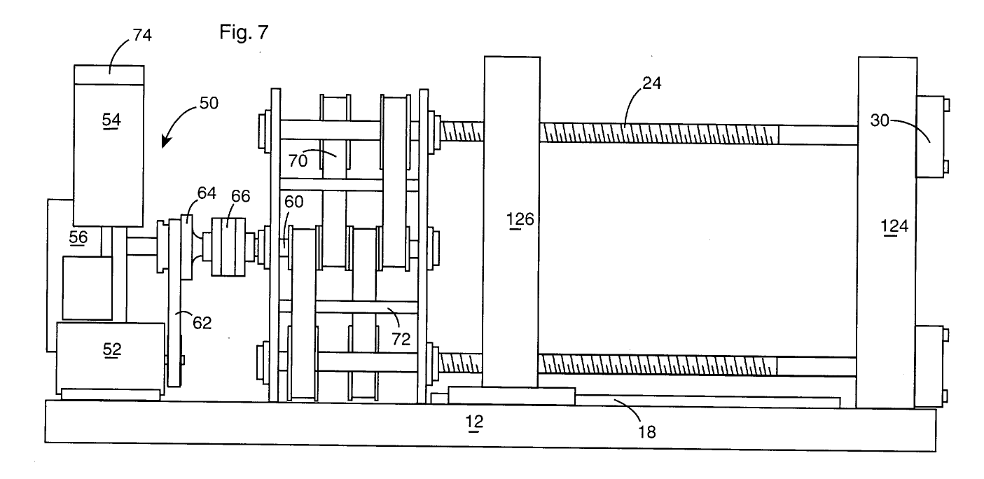

FIGS. 1-5 and the associated description are of an electric molding assembly with one stationary platen and one movable platen, especially adapted for use in injection molding. After reading the description, however, it will be apparent to one skilled in the art that the principles of the invention may also be applied to other plastic molding assemblies, such as blow molding clamp assemblies. Also, it will be apparent that assemblies can be designed with two moveable platens, and with force accumulators positioned on a stationary platen, or on both of two moveable platens. FIGS. 6 and 7 illustrate two of these alternative configurations.

As best illustrated in FIGS. 1-4, the preferred clamping assembly, generally 10, is comprised of a base 12, which supports stationary platen 14 and moveable platen 16, which is slideable along platen carriage 18. Platens 14 and 16 include facing, parallel, mold support faces 20 and 22, respectively.

Platens 14 and 16 are connected by threaded rods 24, each rod having a proximal end rotatably attached to support frame 26, and a distal end rotatably attached to stationary platen 14. Threaded rods 24 are parallel to each other and perpendicular to mold support faces 20 and 22, and extend through bores 28 in moveable platen 16.

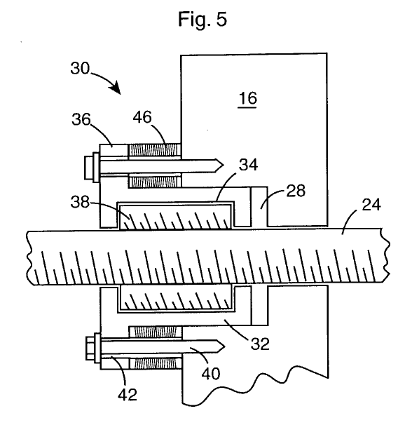

Threaded rods 24 are joined to the proximal side of moveable platen 16 by disc springs 30. FIG. 5 provides a detailed sectional side view of disc spring 30. Disc spring 30 is comprised of slideable cylindrical housing 32 having a cylindrical internal bore 34 for receiving rod 24, and flange 36 having a circumference greater than housing 32 adjacent the proximal end of housing 32.

A plurality of planetary rollers 38 having threads meshing with the threads of rod 24 are carried within the wall of bore 34. Disc spring 30 is carried on a plurality of bolts 40 bolted into the proximal side of platen 16. Bolts 40 extend through bores 42 in flange 34, with bores 42 having a greater diameter than bolts 40, so that disc spring 30 is slideable on bolts 40 between uncompressed and compressed positions.

Disc spring 30 also includes a plurality of annular washers or discs 46. As illustrated, sixteen discs 46 are used in alternating sets of four each. It will be understood, however, that a greater or lesser number of discs can be used, and that the disc springs may be arranged in a different manner. Disc springs 46 are slidably positioned around rod 24, and between the distal side of flange 36 and the proximal side of platen 16.

Threaded rods 24 are simultaneously rotated by a common drive means, generally 50, comprised of a first electric motor 52, and a second electric motor 54 joined to a reduction gear box 56. A drive shaft 60 extends along a pathway parallel to, and equidistant from, the pathways of threaded rods 24. Belt 62 extends around the shaft of motor 52 and clutch 64 on the shaft of gear box 56. The shaft of gear box 56 is joined to drive shaft 60, with coupling 66.

Drive shaft 60 is connected to threaded rods 24 with a transmission means comprised of belts 70 extending around pulleys on drive shaft 60 and rods 24. Tension on belts 70 is adjusted with belt tensioners 72. All belts and pulleys are as identical, as are the diameters and thread configurations of threaded rods 24, in order to maintain surfaces 20 and 22 of platens 14 and 16 parallel during closing of clamping assembly 10.

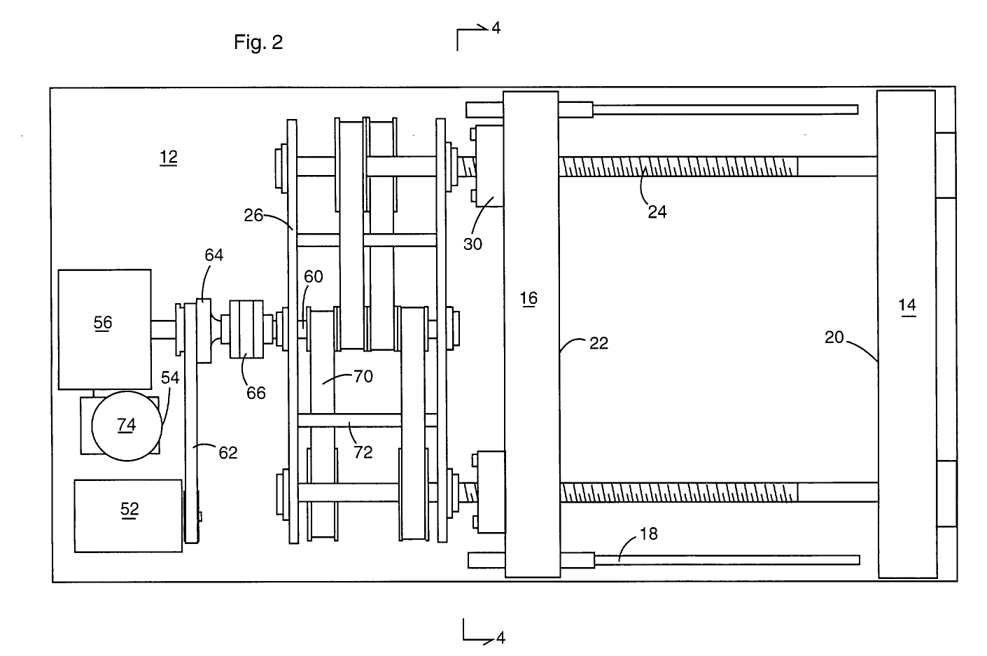

Motor 52 preferably has a horsepower rating of from about 1 to about 30, and is adapted to rapidly rotate drive shaft 60 at a relatively high speed to move platen 16 between an open position, shown in FIGS. 1 and 2, and a closed position (not shown) adjacent stationary platen 14, with spacing being provided for first and second mold sections (not shown) carried on faces 18 and 20 of platens 14 and 16. Upon closing of mold assembly 10, the mold sections abut to form a complete mold cavity, which is subsequently injected with the desired plastic through inlets (not shown) in stationary platen 14.

Movement of platen 16 to its closed position serves to bring mold sections on platens 14 and 16 substantially together, i.e., either touching or almost touching. Platen 16 is then moved to its clamping position, in which a high pressure is exerted on platen 16. Movement of platen 16 and creation of the high clamping pressure is achieved by engaging low-speed motor 54.

Motor 54 preferably has a horsepower in the range of from about 5 to about 50, i.e., from about 2 to about 4 times greater than motor 52. In addition, motor 54 is connected to drive shaft 60 through gearbox 56, which may include reduction gearing of, for example, from about 150:1 to about 450:1. As a result, motor 54 rotates drive shaft 60, and thereby rods 24, at a much slower rate than the rotation by motor 52, but with considerably greater torque. Motor 52 may be de-energized during molding. Motor 52 may also be configured with a shaft encoder (not shown) to monitor the position of the moveable platen and determine the activation and direction of the two motors. If so, motor 52 may remain energized during the clamping stage, effectively resulting in two motors contributing to the compression of disc springs 30.

Since platen 16 is in the closed position upon actuation of motor 54, rotation of drive shaft 60 by motor 54 does not result in any significant linear movement of platen 16. Instead, rotation of the rods 24, causes rotation of planetary rollers 38 within each of disc springs 30, causing disc springs 30 to move in a linearly in a distal direction within bore 28 in platen 16, compressing springs 46. Compression of springs 46 in disc spring 30 results in a considerable force against the proximal face of platen 16, thereby clamping mold sections held between platens 14 and 16 tightly together during injection molding. Depending on the motor size and gearing, and the construction of the disc springs, a force on the order of 100-1000 tons of force may be exerted against the moveable platen.

To maintain the desired force during molding, motor 54 can be run during all or part of the molding process, e.g., during the injection stage, and/or motor 54 can include brake 74, which is engaged if motor 54 is disengaged during molding. After the molding cycle is complete, motor 54 is disengaged, and motor 52 is run in reverse to rapidly move platen 16 to its open position in preparation for the next molding cycle.

FIG. 6 illustrates an alternative clamping assembly using two platens 114 and 116, both platens being moveable between open and closed positions on threaded rods 118. Disc springs 30 are mounted on the exterior of surfaces of both platens. In operation, rotation of rods 118 causes platens 114 and 116 to move inwardly toward each other to their closed position. Further rotation of rods 118 causes disc springs 30 to move to their compressed positions, clamping platens 114 and 116 tightly together.

FIG. 7 illustrates another clamping assembly using a stationary platen 124 and a moveable platen 126, with disc springs 30 being mounted on stationary platen 124. In preparation for molding, rods 24 are rotated to move platen 126 inwardly to its closed position, causing mold sections (not shown) on the inner mounting surfaces of platens 124 and 126 to come together. Further rotation of rods 24 causes disc springs 30 to move inwardly creating the desired clamping force.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A molding clamp assembly comprising:
a) first and second platens having facing, parallel mold section support surfaces, at least one of said platens being moveable between open and closed positions along a pathway perpendicular to said support surfaces;
b) threaded rods parallel to said pathway;
c) force accumulators mounted on at least one of said platens and carried on said threaded rods, said accumulators being moveable between uncompressed and compressed positions; and
d) an electric drive means adapted to rotate said threaded rods to move at least one of said moveable platens between said open and closed positions, and to rotate said threaded rods to compress said force accumulators when said movable platen is in the closed position.

2. The clamp assembly of claim 1, wherein both of said platens are moveable.

3. The clamp assembly of claim 1, wherein said force accumulators are mounted on both platens.

4. The clamp assembly of claim 1, wherein said force accumulators are mounted on said moveable platen.

5. The clamp assembly of claim 1, wherein one of said platens is stationary and said force accumulators are mounted on said stationary platen.

6. The clamp assembly of claim 1, wherein said platens include exterior surfaces opposite said mold section supporting surfaces, and said force accumulators are mounted on the exterior surface of at least one of said platens, each of said force accumulators includes a flange spaced from the exterior surface of a platen, and a compressible element between said flange and said platen.

7. The clamp assembly of claim 1, wherein said force accumulators are linearly moveable on said threaded rods.

8. The clamp assembly of claim 1, wherein each of said force accumulators includes rollers meshing with one of said threaded rods, whereby rotation of said threaded rod causes said force accumulator to move linearly along said threaded rod.

9. The clamp assembly of claim 1, wherein said electric drive means includes a first electric motor adapted to rotate said threaded rods to move said moveable platen between said open and closed positions, and a second electric motor adapted to rotate said threaded rods to move said accumulators between said uncompressed and compressed positions when said movable platen is in its closed position.

10. The clamp assembly of claim 1, wherein said force accumulators are disc springs.

11. A molding clamp assembly comprising:
a) a base;
b) a stationary platen having a first mold section support surface fixedly mounted on said base;
c) a moveable platen having a second mold section support surface, and a proximal face opposite said support surface, said moveable platen being slidable on said base along a pathway between open and closed positions, said first and second faces being toward each other, perpendicular to said pathway, and substantially parallel;
d) threaded rods parallel to said pathway, said rods having distal ends rotatable secured to said stationary platen;
e) force accumulators mounted on said moveable platen and carried on said threaded rods, said accumulators being moveable between uncompressed and compressed positions; and
f) an electric drive means adapted to rotate said threaded rods to move said moveable platen between said open and closed positions, and to rotate said threaded rods to compress said force accumulators when said movable platen is in the closed position.

12. The clamp assembly of claim 11, wherein said force accumulators are mounted on the proximal surface of said movable platen.

13. The clamp assembly of claim 11, wherein said force accumulators are linearly moveable on said threaded rods.

14. The clamp assembly of claim 111, wherein each of said force accumulators includes a flange spaced from the proximal surface of said movable platen, and compressible springs between said flange and said moveable platen, said springs being compressed when said accumulator is compressed.

15. The clamp assembly of claim 11, wherein said moveable platen includes bores extending between the proximal and mold section support surfaces of said moveable platen, said bores having longitudinal axes parallel to said threaded rods, said force accumulators including housings linearly moveable on said threaded rods within said bores.

16. The clamp assembly of claim 11, wherein each of said force accumulators includes threaded components meshing with one of said threaded rods, whereby rotation of said threaded rod, causes said force accumulator to move linearly along said threaded rod.

17. The clamp assembly of claim 11, wherein said force accumulators are disc springs.

18. An injection molding clamp assembly comprising:
a) a base having a platen carriage with a longitudinal axis;
b) a stationary platen having a first mold section support surface fixedly mounted on said base;
c) a moveable platen having a second mold section support surface, and a proximal surface opposite said second support surface, said moveable platen being moveable on said platen carriage between open and closed positions, said first and second surfaces being toward each other, transverse to said carriage longitudinal axis, and substantially parallel;
d) parallel threaded rods having distal ends rotatable secured to said stationary platen;
e) force accumulators mounted on said moveable platen and carried on said threaded rods, said accumulators being moveable between uncompressed and compressed positions;
f) a first electric motor adapted to rotate said threaded rods to move said moveable platen between said open and closed positions; and
g) a second electric motor adapted to rotate said threaded rods to move said accumulators between said uncompressed and compressed positions when said movable platen is in its closed position.

19. The clamping assembly of claim 18, further including a drive shaft rotatable by either of said motors, said drive shaft being connected to each of said threaded rods.

20. The clamping assembly of claim 18, further including a reducing gearbox, said second motor being connected through said gearbox to said threaded rods.

21. The clamping assembly of claim 18, wherein said force accumulators are slidably mounted on the proximal face of said movable platen and linearly moveable on said threaded rods.

22. The clamp assembly of claim 21, wherein each of said force accumulators includes a flange spaced from the proximal surface of said movable platen, and compressible springs between said flange and said moveable platen, said springs being compressed when said accumulator is compressed.

23. The clamp assembly of claim 21, wherein said moveable platen includes bores extending between the proximal and mold section support surfaces of said moveable platen, said bores having longitudinal axes parallel to said threaded rods, said force accumulators including housings linearly moveable on said threaded rods within said bores.

24. The clamp assembly of claim 18, wherein said force accumulators are disc springs.

25. An injection molding clamp assembly comprising:
a) a support having a platen carriage with a longitudinal axis;
b) a stationary platen having four corners and a first mold section support surface fixedly mounted on said support;
c) a moveable platen having four corners, through bores adjacent each corner, and a second mold section support surface moveable on said platen carriage between open and closed positions, said first and second surfaces being toward each other, transverse to said carriage longitudinal axis, and substantially parallel;
d) parallel threaded rods having distal ends rotatable secured to said stationary platen and extending through the bores in said moveable platen;
e) force accumulators mounted on said moveable platen and carried on said threaded rods, said accumulators being linearly moveable on said rods relative to said moveable platen between uncompressed and compressed positions;
f) a first electric drive means adapted to rotate said threaded rods at a first rotational speed to move said moveable platen between said open and closed positions; and
g) a second electric drive means adapted to rotate said threaded rods at a second rotational speed less than said first rotational speed to move said accumulators between said uncompressed and compressed positions when said movable platen is in its closed position.

26. The clamp of claim 25, wherein said first electric drive means is comprised of a first electric motor, a drive shaft rotatable by said electric motor, and transmission means connecting said drive shaft to said threaded rods to simultaneously rotate said rods at the same rate, and said second electric drive means is comprised of a second electric motor connected to said drive shaft through a reduction gearbox.

27. The clamp of claim 25, wherein said force accumulators are disc springs.

28. The clamp of claim 25, wherein said second drive means includes an electric motor with a brake.

29. The clamp of claim 26, wherein said transmission means is a plurality of tensionable belts, with each belt extending around said drive shaft and one of said threaded rods.

30. A molding clamp assembly comprising:
a) A platen carriage with a longitudinal axis;
b) a first moveable platen having a first mold section support surface;
c) a second moveable platen having a second mold section support surface, said first and second platens being moveable along the longitudinal axis of said carriage between open and closed positions, said first and second surfaces being toward each other, transverse to said carriage longitudinal axis, and substantially parallel;
d) parallel threaded rods connecting said platens;
e) force accumulators mounted on at least one of said moveable platens and carried on said threaded rods, said accumulators being moveable between uncompressed and compressed positions; and
f) an electric drive means adapted to rotate said threaded rods to move at least one of said moveable platens between said open and closed positions, and to rotate said threaded rods to compress said force accumulators when said movable platen is in the closed position.

31. The clamp assembly of claim 30, wherein said force accumulators are mounted on both platens.

32. The clamp assembly of claim 30, wherein said platens include exterior surfaces opposite said mold section supporting surfaces, and said force accumulators are mounted on the exterior surface of at least one of said platens.

33. The clamp assembly of claim 30, wherein said force accumulators are linearly moveable on said threaded rods.

34. The clamp assembly of claim 30, wherein each of said force accumulators includes threaded components meshing with one of said threaded rods, whereby rotation of said threaded rod causes said force accumulator to move linearly along said threaded rod.

35. The clamp assembly of claim 30, wherein said electric drive means includes a first electric motor adapted to rotate said threaded rods to move said moveable platen between said open and closed positions, and a second electric motor adapted to rotate said threaded rods to move said accumulators between said uncompressed and compressed positions when said movable platen is in its closed position.
